(19) United States
(12) Patent Application Publication
(10) Pub. No.: US 2004/0003965 A1
(43) Pub. Date: Jan. 8, 2004

(54) Verba brace

(76) Inventor: Steven Barry Grover, East Greenville, PA (US)

Correspondence Address: Steven Barry Grover, 346 State Street, East Greenville, PA, 18041, US

(21) Appl. No.: 10/186,606

(22) Filed: Jul. 2, 2002

(51) Int. Cl. E06C 7/06

(52) U.S. Cl. 182/107; 182/214

(57) ABSTRACT

My invention will secure a ladder to a building or roof and will not slide or come loose. Saving Lives.

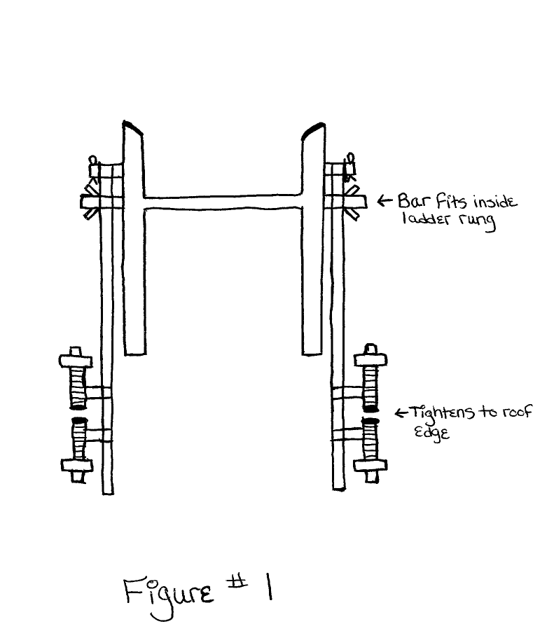

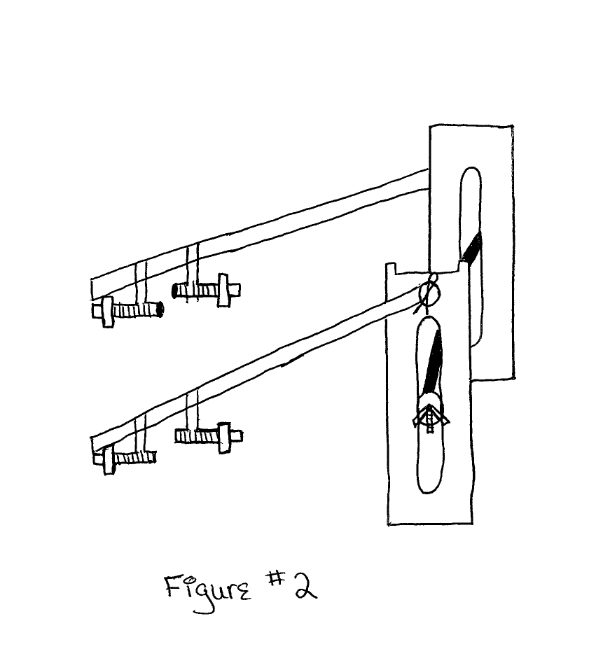

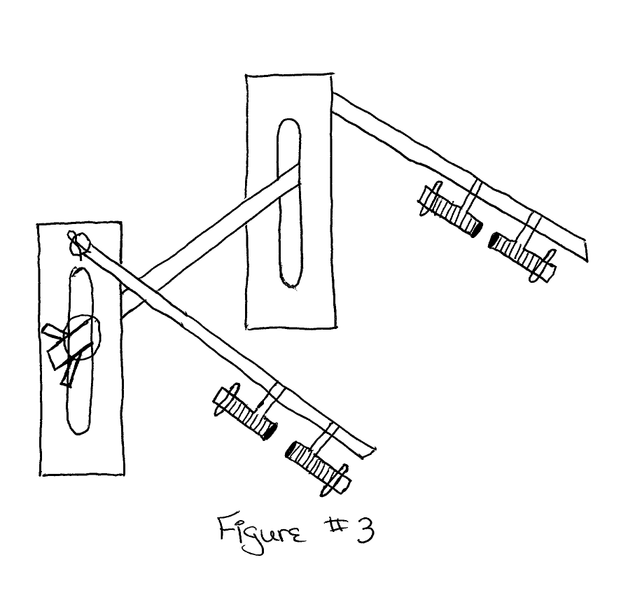

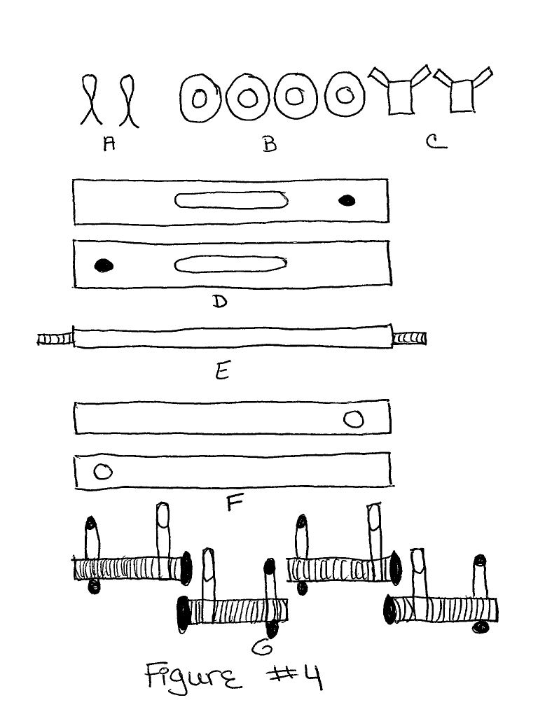

### CROSS REFERENCE TO RELATED APPLICATIONS

“Not Applicable”

### STATEMENT REGUARDING FEDERALLY SPONSORED RESEARCH

“Not Applicable”

### REFERENCE TO SEQUENCE LISTING

“Not Applicable”

### BACKGROUND OF INVENTION

The field of endeavor to which the invention pertains is anyone using a tall ladder such as roofers or construction workers, can also be for home use.

### BRIEF SUMMARY OF THE INVENTION

I have designed this product to secure a ladder to a building as to prevent the ladder from sliding or falling. With all my years experience in construction, I have never seen a secure way to attach a ladder, except with bungee cords which tend to snap causing the ladder to give way and fall.

### BRIEF DESCRIPTION OF SEVERAL VIEWS OF THE DRAWING

“See Attached”

### DETAILED DESCRIPTION OF THE INVENTION

Once the Verba Brace is attached to a ladder it is to be secured to a roof Once secured to the roof the ladder will not fall.

See Attached for each piece and directions of assembly.

1. What I claim as my invention is a way to secure an extension ladder to a building or roof that will prevent it from sliding or falling.
